(19) United States
(12) Patent Application Publication
(10) Pub. No.: US 2007/0298785 A1
(43) Pub. Date: Dec. 27, 2007

(54) CHARACTER INPUT DEVICE AND METHOD FOR MOBILE TERMINAL

(75) Inventor: Sung-Jun LEE, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/769,341

(22) Filed: Jun. 27, 2007

(30) Foreign Application Priority Data
Jun. 27, 2006 (KR) 2006-0057804

(51) Int. Cl. H04Q 7/20

(52) U.S. Cl. 455/425

(57) ABSTRACT

Provided is a character input method and device for a mobile terminal. The device includes a touch sensor, a memory, and a controller. The touch sensor senses a user's touch, and generates a sensing signal. The memory stores at least one character mapping table for storing a mapping relationship between a character and a touch type. In a character input mode, the controller analyzes the sensing signal from the touch sensor, determines the touch type, accesses the character mapping table, and identifies an input character depending on the touch type.

### PRIORITY

This application claims priority under 35 U.S.C. § 119 to an application filed in the Korean Intellectual Property Office on Jun. 27, 2006 and assigned Serial No. 2006-57804, the contents of which are incorporated herein by reference.

### BACKGROUND OF THE INVENTION

1. Field of the Invention

The present invention relates generally to a character input device and method for a mobile terminal, and in particular, to a device and method for inputting a character using a small-sized touch pad in a mobile terminal.

2. Description of the Related Art In a description below, the term “character” includes all English alphabets, Korean alphabets, numerals, and special characters (e.g., *, #, and the like) that can be inputted using a keypad of a mobile terminal.

The development of various electronic and communication industries contributes to the wide spreading of the mobile terminal, and the trend of functional diversification, miniaturization, light weight, and slimness of the mobile terminal according to user's demands.

In addition to a simple call function, various functions of downloading a music file and listening to music, downloading a Video On Demand (VOD) and watching a moving picture, and photographing an object and storing a photograph album are being provided in software. Further, peripheral instruments attached or added for use in the mobile terminal are under development in hardware. For example, there can be mainly provided an attachable or built-in digital camera module, a TV reception module for watching sky broadcast, and an MP3 player module for playing an MP3 file.

An input unit of the mobile terminal for performing the above various functions is much evolving as well. For example, a navigation keypad assembly for serving various contents in an initial 3×4 keypad is under development. In addition, key buttons that are installed on an outer surface of the mobile terminal and enable various manipulations, e.g., playing and stopping an MP3 file in an MP3 player and photographing an object in a camera module with the mobile terminal not opened are under development.

As described above, the mobile terminal currently in use is of a type in which special keys are added to the 3×4 keypad according to purpose. Numerals and English alphabet mapped in the 3×4 keypad are based on a standardized rule for all manufacturers. The Korean alphabet (“Hangeul”) is based on an inherent mapping rule of each manufacturer. In general, a plurality of characters is mapped to one key, and an input character is identified depending on the number of times of pressing the key.

FIG. 1 illustrates a conventional keypad of a mobile terminal.

As shown in FIG. 1, a plurality of Korean consonants and a plurality of English letters are mapped to one key. For example, Korean consonants [symbol] and [symbol] and English letters “G”, “H”, and “I” are mapped to numeral key “4”. Such a mapping rule established from a research for reducing the number of times of pressing a key.

A conventional character input method requires at least twelve keys arranged on the keypad of the mobile terminal. Key buttons are additionally required as the mobile terminal increases in function. Thus, there occurs a drawback in that addition of the key buttons does not conform to the trend of the mobile terminal seeking miniaturization and slimness.

In recent years, various input devices are under development in addition to the keypad. For example, there are a touch screen for a Liquid Crystal Display (LCD) of the mobile terminal, and a touch pad mounted on a body of the mobile terminal. Also, several recent actions for making much use of the input devices in place of the typical keypad are in progress. In particular, the touch pad actively used as the input device would be able to eliminate limitations to a size and a design of the mobile terminal, which are caused by the use of the keypad, because it is very small in size.

### SUMMARY OF THE INVENTION

An aspect of the present invention is to substantially solve at least the above problems and/or disadvantages and to provide at least the advantages below.

Accordingly, an aspect of the present invention is to provide a character input device and method for inputting a character using a touch pad in a mobile terminal.

Another aspect of the present invention is to provide a character input device and method for inputting a character using a touch sensor in a mobile terminal.

A further aspect of the present invention is to provide a character input device and method for identifying an input character depending on finger (or stylus pen) touch time, number of times, and direction in a mobile terminal.

The above aspects are achieved by providing a character input device and method for a mobile terminal.

According to one aspect of the present invention, there is provided a character input method for a mobile terminal having a touch sensor. The method includes analyzing a sensing signal from the touch sensor, and determining a touch type, in a character input mode; and identifying an input character depending on the touch type, using a character mapping table.

According to another aspect of the present invention, there is provided a character input device for a mobile terminal. The device includes a touch sensor for sensing a user's touch, and generating a sensing signal; a memory for storing at least one character mapping table for storing a mapping relationship between a character and a touch type; and a controller for, in a character input mode, analyzing the sensing signal from the touch sensor, determining the touch type, accessing the character mapping table, and identifying an input character depending on the touch type.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a conventional keypad of a mobile terminal;

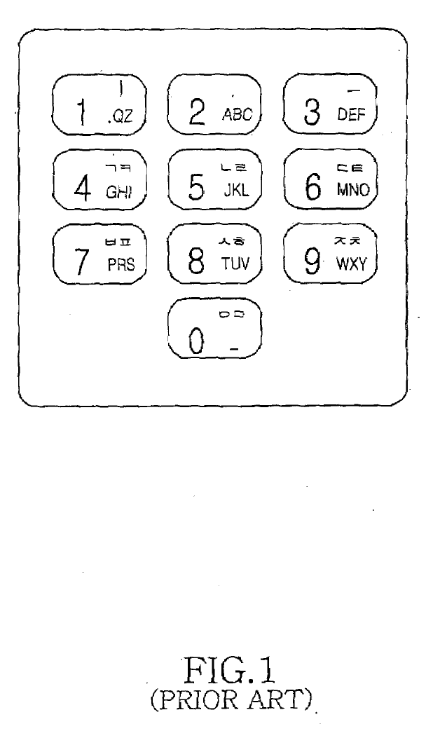

FIG. 2 is a block diagram illustrating a construction of a mobile terminal according to the present invention;

FIG. 3 is a flowchart illustrating a character input method for inputting a character using a touch pad in a mobile terminal according to the present invention;

FIG. 4 is a diagram illustrating a method for inputting a numeral using a touch pad according to the present invention;

FIG. 5 is a diagram illustrating a method for inputting English alphabet using a touch pad according to the present invention; and

FIG. 6 is a diagram illustrating a method for inputting Korean alphabet using a touch pad according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail. The terms described below, as terms defined considering their functions in the present invention, can be different depending on a user or operator's intention or a practice. Thus, the definition should be made on the basis of the contents throughout this specification.

A technology for inputting a character using a touch sensor in a mobile terminal according to the present invention will be described below. As the touch sensor for sensing a finger (or stylus pen) touch, there is a touch screen, a touch pad, or the like. A description below will be made on the basis of the touch pad, as an example. The touch pad typically has a size (e.g., 25 mm×25 mm) suitable to sense a direction of a minute finger motion, and can be variously designed depending on a shape of the mobile terminal.

The term “mobile terminal” designates all portable small-sized terminals. As the mobile terminal, there is for example a wireless communication terminal, a Personal Data Assistant (PDA), an MP3 player, a Bluetooth® instrument, or a digital camera. A description below will be made on the basis of the wireless communication terminal, for example.

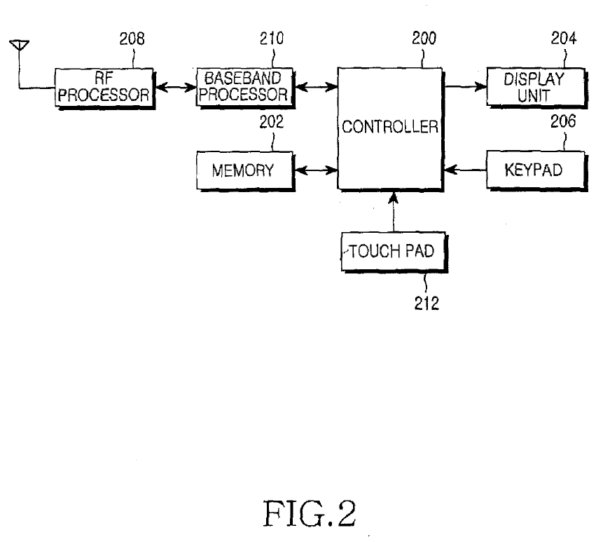

FIG. 2 is a block diagram illustrating a construction of a mobile terminal according to the present invention. Here, the term “mobile terminal” refers to all terminals for enabling a message communication, such as 2G and 3G Code Division Multiple Access (CDMA) terminals and a 4G broadband wireless access terminal. A description below will be described on the basis of constructions of the above terminals.

Referring to FIG. 2, the mobile terminal includes a controller 200, a memory 202, a display unit 204, a keypad 206, a Radio Frequency (RF) processor 208, a baseband processor 210, and a touch pad 212.

The controller 200 controls a general operation of the terminal. For example, the controller 200 performs a process and a control for voice communication and data communication. In addition to a general function, the controller 200 analyzes a sensing signal input from the touch pad 212, and identifies and controls the display of an input character according to the present invention.

The memory 202 includes a program memory, a data memory, and a nonvolatile memory. The memory 202 stores a program for controlling the general operation of the terminal, temporary data generated while the terminal is enabled, a system parameter, and other storage data (e.g., a telephone number and a message). According to the present invention, the memory 202 stores a character mapping table for storing a mapping relationship between a touch type and a character. In detail, the memory 202 can store a character mapping table for each Korean alphabet input mode, English alphabet input mode, numeral input mode, and special character input mode.

The display unit 204 displays state information (or an indicator) generated while the terminal is enabled, a user input character, a moving picture, and a still picture. The display unit 204 can use a liquid crystal display (LCD). The display unit 204 can be also enabled as an input device when the LCD is realized in a touch screen form.

The keypad 206 includes a plurality of keys, and provides key input data corresponding to a key pressed by a user to the controller 200. In the present invention, the keypad 206 can have function keys to the minimum because the character is input using the touch pad 212.

The RF processor 208 processes an RF signal exchanged through an antenna. The baseband processor 210 processes a baseband signal exchanged between the RF processor 208 and the controller 200.

The touch pad 212 senses the finger (or stylus pen) touch, and provides the sensing signal to the controller 200. The touch pad 212 can sense the finger touch by an optical scanner method and a non-optical scanner method. It is assumed that a non-optical sensor with a relatively small volume, such as a heat sensor, a semiconductor sensor, an LCD sensor, an ultrasonic sensor, and a capacitor sensor, is used in the present invention.

Prior to a detailed description of an operation, the character mapping tables 30 stored in the memory 202 will be described below.

The character mapping table for the numeral input mode will be described with reference to Table 1 below.

TABLE 1

| Numeral | Input method |
|---|---|
| 1 | [symbol] |
| 2 | ↑ |
| 3 | [symbol] |
| 4 | ← |
| 5 | . |
| 6 | → |
| 7 | [symbol] |
| 8 | ↓ |
| 9 | [symbol] |
| 0 | .- |

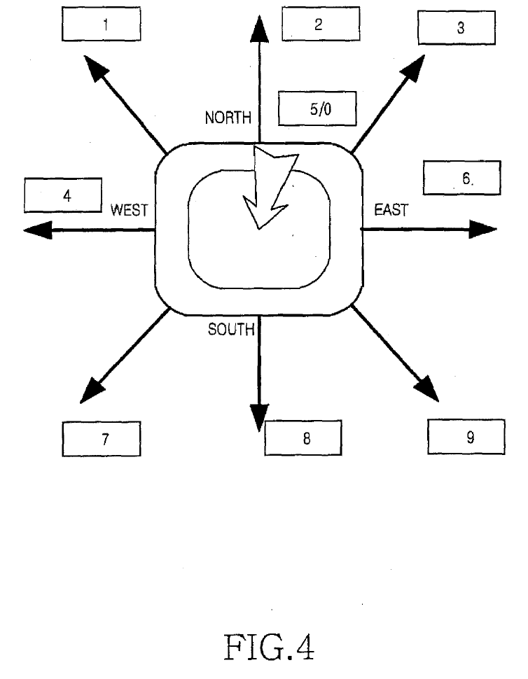

FIG. 4 is a diagram illustrating a method for inputting a numeral using the touch pad according to the present invention.

A mapping rule according to the character mapping table of Table 1 is shown in FIG. 4. The numerals are input using eight directions and the center of the touch pad 212. In the numeral input mode, a numeral “4” is input when a user finger touches and slides left (that is, in a direction towards West) on the touch pad 212. A numeral “6” is input when the finger touches and slides right (that is, in a direction towards East) on the touch pad 212. A numeral “3” is input when the finger touches and slides in a direction towards Northeast on the touch pad 212. A numeral “7 is input when the finger touches and slides in a direction towards Southwest on the touch pad 212. A numeral “5” is input when the user taps the touch pad 212 with the finger once. A numeral “0” is input when the user taps the touch pad 212 with the finger twice quickly.

The character mapping table for the English input mode will be described as in Table 2.

TABLE 2

| | Input |
|---|---|
| English | method |
| A | ↑ |
| B | ↑ - |
| C | ↑ -- |
| D | [symbol] |
| E | [symbol] - |
| F | [symbol] -- |
| G | ← |
| H | ← - |
| I | ← -- |
| J | · |
| K | · - |
| L | · -- |
| M | → |
| N | → - |
| O | → -- |
| P | [symbol] |
| Q | [symbol] - |
| R | [symbol] - |
| S | [symbol] -- |
| T | ↓ |
| U | ↓ - |
| V | ↓ -- |
| W | [symbol] |
| X | [symbol] - |
| Y | [symbol] -- |
| Z | [symbol] -- |
| · | [symbol] |

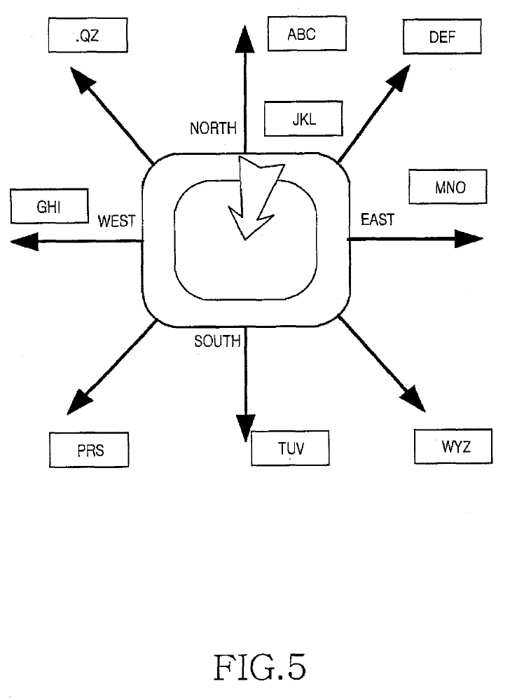

FIG. 5 is a diagram illustrating a method for inputting English using the touch pad according to the present invention.

A mapping rule according to the character mapping table of Table 2 is shown in FIG. 5, and is the same as that of a general keypad. A plurality of English letters is mapped to one direction. A time of touch duration in the same direction is detected to identify the input letters. Current touch direction and touch duration can be displayed on a display window so that the user can recognize them, because there is a difference in each individual's sense of touch. For example, English letters “A”, “B”, and “C” are input when the finger touches and slides in a direction towards North on the touch pad 212. The “A”, “B”, and “C” are identified depending on the touch duration, respectively. English alphabets “J”, “K”, and “L” with no direction are identified depending on a duration for which the center is pressed. Thus, a sentence of “MY NAME IS JUN” is input as in “→ [symbol] — →- ↑ → [symbol] - ←— [symbol] — •↓- →”.

The character mapping table for the Korean alphabet input mode will be described as in Table 3.

TABLE 3

| Korean | Input | Korean | Input | Korean | Input |
|---|---|---|---|---|---|
| Consonant | method | Consonent | method | Vowel | method |
| [symbol] | [symbol] | [symbol] | [symbol] - | [symbol] | ↓ |
| [symbol] | ↑ | [symbol] | [symbol] | [symbol] | → |
| [symbol] | [symbol] | [symbol] | [symbol] - | · | · |
| [symbol] | ↑ - | [symbol] | [symbol] - | [symbol] | ↓ · |
| [symbol] | [symbol] | [symbol] | [symbol] - | ⊥ | · → |
| [symbol] | [symbol] | [symbol] | [symbol] -- | [symbol] | → · |
| [symbol] | [symbol] | [symbol] | [symbol] -- | [symbol] | ↓ · · |

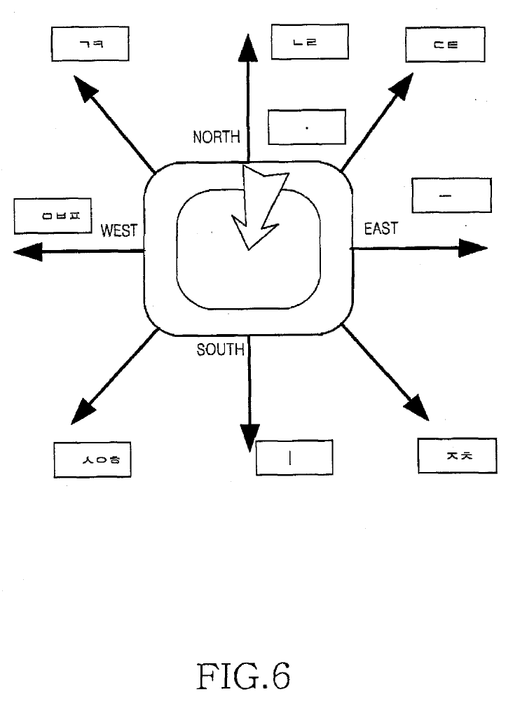

FIG. 6 is a diagram illustrating a method for inputting Korean alphabet using the touch pad according to the present invention.

A mapping rule according to the character mapping table of Table 3 is shown in FIG. 6. A plurality of Korean letters or characters is mapped to one direction. A touch duration in the same direction is detected to identify the input characters. For example, Korean letter “ [symbol] ” is input when the finger touches and slides up for a short duration as put on the touch pad 212. Korean letter “ [symbol] ” is input when the finger touches and slides up for a long time as put on the touch pad 212. Korean double consonant is input when the finger touches and slides twice in the direction mapped to a corresponding character. For example, Korean double consonant “ [symbol] ” is input when the finger touches and slides up twice. It is assumed that a vowel combination uses a vowel input method that is called CHEON JI IN of SAMSUNG. Korean vowel “ [symbol] ” is input when the finger touches and slides left to right. Korean vowel “ [symbol] ” is input when the finger touches and slides up then down. Korean vowel “ [symbol] ” is input when the user quickly taps the touch pad 212. For example, Korean vowel “ [symbol] ” is input when the finger touches and slides up then down, and taps the center of the touch pad 212 once. Thus, a Korean sentence “ [symbol] ” is input as in “↑↓. ↑→↓ [symbol] •↓ [symbol] - [symbol] →•↑ [symbol] -↓←- ↑↓ [symbol] ↓•”.

The mapping rules of Tables 1 to 3 are exemplarily provided, and are not intended to limit the scope of the present invention. Thus, it is obvious to those skilled in the art that other mapping rules can be used.

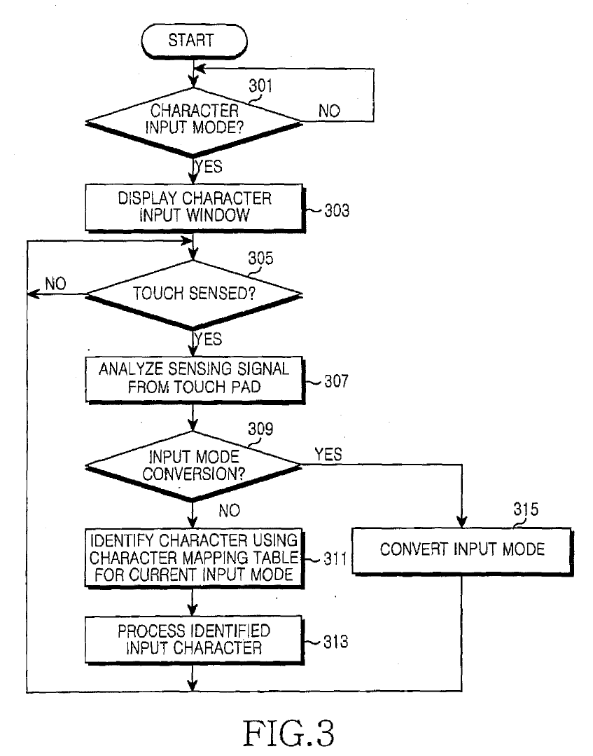

FIG. 3 is a flowchart illustrating a character input method for inputting the character using the touch pad in the mobile terminal according to the present invention.

Referring to FIG. 3, the controller 200 checks whether it is in the character input mode by user's manipulation in Step 301. For example, the character input mode can be a message edit mode, a memo input mode, and a schedule input mode. In Step 303, the controller 200 displays a character input window on a screen when it is in the character input mode.

In Step 305, the controller 200 analyzes the sensing signal from the touch pad 212, and senses whether the user touches on the touch pad 212 with the finger. In Step 307, the controller 200 analyzes the sensing signal, and senses a touch type (duration, number of taps, and slide direction), when sensing the touch on the touch pad 212. The controller 200 can display the touch type and the input character corresponding to the touch type through a display window so that the user can recognize them.

In Step 309, the controller 200 determines whether the touch type indicates input mode conversion. For example, the controller 200 determines that the touch type indicates the input mode conversion, when sensing the touch duration above a threshold value. It is assumed that a default mode is the numeral input mode at the time of conversion to the character input mode. The controller 200 converts the character input mode to the numeral input mode, when the touch duration is greater than a first threshold value (TH1) and is less than a second threshold value (TH2). The controller 200 converts the character input mode to the English input mode, when the touch duration is greater than the second threshold value (TH2) and is less than a third threshold value (TH3). The controller 200 converts the character input mode to the Korean alphabet input mode when the touch duration is greater than the third threshold value (TH3).

In Step 315, the controller 200 performs the input mode conversion depending on the touch type when the touch type indicates the input mode conversion, and returns to the Step 305 to keep sensing the touch.

In Step 311, the controller 200 accesses a character mapping table for a current input mode, and identifies the input character depending on the touch type, when the touch type does not indicate the input mode conversion. In Step 313, the controller 200 processes the identified input character, and returns to the Step 305 to keep sensing the touch. In other words, the controller 200 finalizes and displays the identified input character on the display window.

The character input method according to an exemplary embodiment of the present invention is described above, but the touch pad 212 can be much utilized as a means for user's manipulation such as a menu search mode in place of a general keypad, in addition to character input. For example, the touch pad 212 can be realized such that, in the menu search mode, it returns to an upper menu when the user taps the touch pad 212 twice, a focus moves when the user taps once, and a detailed content of a menu item where the focus is located is accessed when the user touches and holds.

As described above, the present invention has an advantage of using the small-sized touch pad as an input means, thereby supporting a miniaturization and various designs of the terminal. In other words, the present invention can support the small-sized terminal, widen a screen of the LCD, and support the development of the terminal having various designs according to the latest trends.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A character input method for a mobile terminal having a touch sensor, the method comprising:
analyzing a sensing signal from the touch sensor, and determining a touch type, in a character input mode; and
identifying an input character depending on the touch type, using a character mapping table.

2. The method of claim 1, wherein the identifying step comprises:
checking whether the touch type indicates an input mode conversion; and
accessing a character mapping table based on a current input mode, and identifying the input character depending on the touch type, when the touch type does not indicate the input mode conversion.

3. The method of claim 2, further comprising converting an input mode when the touch type indicates the input mode conversion.

4. The method of claim 2, wherein the character input mode comprises at least one of a numeral input mode, an English input mode, a Korean input mode, and a special character input mode.

5. The method of claim 1, wherein the touch type comprises at least one of touch duration, number of sequential taps, and slide direction.

6. The method of claim 1, further comprising finalizing and displaying the identified input character on a display window.

7. The method of claim 1, further comprising displaying the determined touch type on a display window.

8. The method of claim 1, wherein the determining step comprises:
checking whether the sensing signal is generated from the touch sensor; and
analyzing the sensing signal, and determining touch duration time, number of sequential taps, and slide direction upon generation of the sensing signal.

9. The method of claim 1, wherein the touch sensor is one of a touch pad and a touch screen.

10. The method of claim 1, wherein the character mapping table is one of a mapping table for storing a mapping relationship between a numeral and a touch type, a mapping table for storing a mapping relationship between Korean alphabet and a touch type, a mapping table for storing a mapping relationship between English alphabet and a touch type, and a mapping table for storing a mapping relationship between special characters and a touch type.

11. A character input device for a mobile terminal, the device comprising:
a touch sensor for sensing a user's touch, and for generating a sensing signal;
a memory for storing at least one character mapping table for storing a mapping relationship between a character and a touch type; and
a controller for, in a character input mode, analyzing the sensing signal, determining the touch type, accessing the character mapping table, and identifying an input character depending on the touch type.

12. The device of claim 11, wherein the controller converts an input mode when the touch type indicates input mode conversion.

13. The device of claim 12, wherein the character input mode comprises at least one of a numeral input mode, an English alphabet input mode, a Korean alphabet input mode, and a special character input mode.

14. The device of claim 11, wherein the touch type comprises at least one of touch duration, number of sequential taps, and slide direction.

15. The device of claim 11, further comprising a display unit for displaying the determined touch type.

16. The device of claim 11, further comprising a display unit for displaying the identified input character.

17. The device of claim 11, wherein the touch sensor is one of a touch pad and a touch screen.

18. The device of claim 11, wherein the character mapping table is one of a mapping table for storing a mapping relationship between a numeral and a touch type, a mapping table for storing a mapping relationship between Korean alphabet and a touch type, a mapping table for storing a mapping relationship between English alphabet and a touch type, and a mapping table for storing a mapping relationship between special characters and a touch type.

19. A character input device for a mobile terminal, the device comprising:
means for analyzing a sensing signal from a touch sensor, and determining a touch type, in a character input mode; and
means for identifying an input character depending on the touch type, using a character mapping table.

20. The device of claim 19, wherein the means for identifying, in order to perform identifying, performs the steps of:
checking whether the touch type indicates an input mode conversion; and
accessing a character mapping table based on a current input mode, and identifying the input character depending on the touch type, when the touch type does not indicate the input mode conversion.
